(19) United States
(12) Patent Application Publication
(10) Pub. No.: US 2007/0113927 A1
(43) Pub. Date: May 24, 2007

(54) ROUTER

(75) Inventor: Hongfeng Zhong, Suzhou (CN)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Positec Power Tools (Suzhou) Co. Ltd., Suzhou (CN)

(21) Appl. No.: 11/554,454

(22) Filed: Oct. 30, 2006

(30) Foreign Application Priority Data
Nov. 9, 2005 (CN) 200510095615.8

(51) Int. Cl. B27C 5/10; B27C 1/00; B23C 1/20

(52) U.S. Cl. 144/136.95; 144/154.5; 409/182

(57) ABSTRACT

A router includes a base for supporting a workpiece and a housing assembly movable with respect to the base by a depth adjustment mechanism in order to adjust the depth of cutting performed on the workpiece by a tool bit carried on the housing assembly. The depth adjustment mechanism includes a wireless remote control device that generates and transmits a radio signal in response to manipulation by an operator. A control unit is mounted on the base to receive the radio signal and generates a control signal for selectively operating a control motor that drives the movement of the housing assembly with respect to the base through a worm-gear based transmission.

### FIELD OF THE INVENTION

The present invention relates generally to a router, and more particularly, to a depth adjustment mechanism of a router.

### BACKGROUND OF THE INVENTION

A router, which comprises a tool bit to work on a workpiece, serves to cut grooves, edges and a variety of shapes in the workpiece. The shapes that are formed on the workpiece are generally determined by the type of the tool bit used in the router and depth of cutting performed by the tool bit. The router moves the tool bit toward and/or away from the workpiece in accordance with the required shape to control the depth of cutting.

U.S. Pat. No. 4,319,860 discloses a plunge router having a housing assembly and a base. The housing assembly and the base comprise a meshing rack and pinion, respectively, and the depth of cutting is adjusted by manually rotating the pinion. However, the manual adjustment is very time-consuming, and accuracy of adjustment is often subject to limitation of human senses.

Another example of plunge router is given in U.S. Pat. No. 6,474,378 B1, which discloses a plunge router having an electronic depth adjustment device that, in response to operator's manipulation, generates a control signal for adjusting the depth of cutting of a tool bit of the router. The prior art reference also provides a solution for the problem that the depth of cutting is invisible when the router is mounted in an inverted position beneath a router table, which solution comprises an auxiliary control panel plugged into the router to make the control panel visible to the user. However, the settling position and operation of the auxiliary control panel are limited by wires powering or signaling the control panel. This certainly causes problem in operation and is thus inconvenient to an operator of the router.

The present invention is aimed to provide a router that overcomes both the accuracy problem and the trouble caused by a wired device.

### SUMMARY OF THE INVENTION

The primary object of the present invention is to provide a router having a depth adjustment mechanism to conveniently adjust the depth of cutting of a tool bit. The router comprises a base; a housing assembly movable with respect to the base and having a drive motor for driving the tool bit through a shaft, a transmission for varying the position of the tool bit with respect to the base, a control motor for driving the transmission to move the tool bit in response to a control signal applied thereto, a depth adjustment mechanism generating the control signal in accordance with a user's input for operating the control motor to control the transmission and thus adjusting the depth of cutting of the tool bit. The depth adjustment mechanism comprises a wireless remote control device comprising first input means responsive to operator manipulation for generating an input signal, first processing means receiving the input signal and generating a radio signal that is transmitted in a wireless manner by a first transmitter, a second receiver and second processing means connected to the control motor, the second receiver receiving the radio signal from the first radio transmitter, the second processing means processing the radio signal and generating the control signal for adjusting the depth of cutting of the tool bit.

Another object of the present invention is to provide a simply-constructed and reliable gear-train-based transmission that comprises a worm gear and a mated worm for carrying out adjustment of depth of cutting of a tool bit.

Further, the router in accordance with the present invention comprises a wireless remote control device for receiving a user's instruction for adjusting the depth of cutting, which enables a user to conveniently perform adjustment of depth of cutting and which is particularly good for use with a fixed-base router that can be mounted in an inverted position beneath a router table. It avoids the user stoop down to observe and adjust the depth of cutting, thereby enhancing the efficiency of operation.

### DESCRIPTION OF THE DRAWING

The present invention will be apparent to those skilled in the art by reading the following description of a preferred embodiment thereof, with reference to the attached drawings, wherein:

FIG. 1 is a front view of a router constructed in accordance with the present invention;

FIG. 2 is a schematic view showing a wireless remote control device of the router in accordance with the present invention;

FIG. 3 is a cross-section view taken along the line III-III of FIG. 1;

FIG. 4 is a cross-section view taken along the line IV-IV of FIG. 3; and

FIG. 5 is a perspective view showing the router of the present invention mounted beneath a router table in an inverted position.

### DETAILED DESCRIPTION OF THE PREFERRED EMBODIMENT

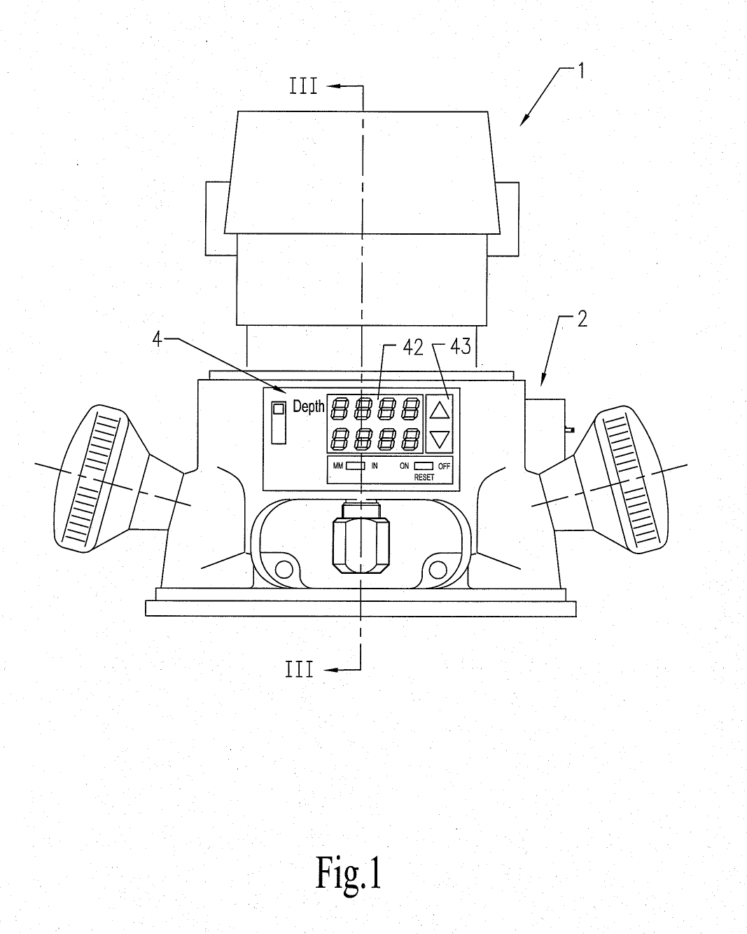

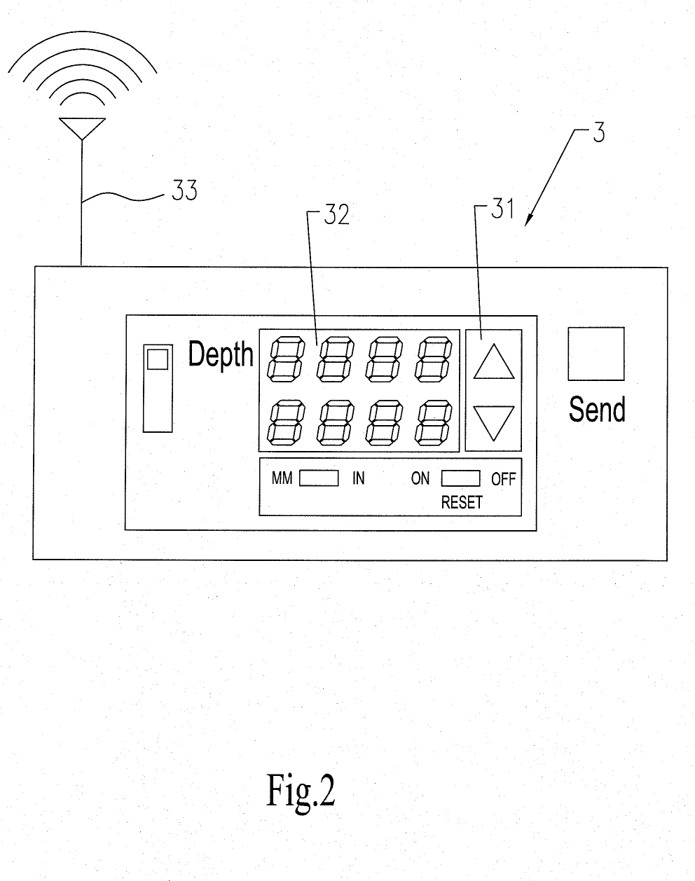

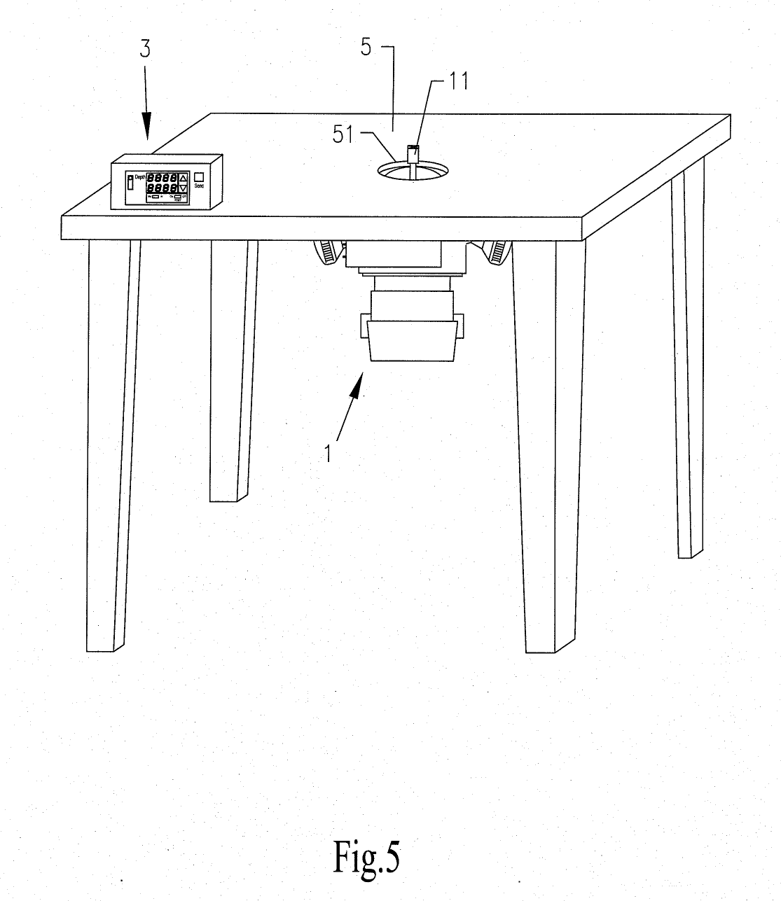

With reference to the drawings and in particular to FIGS. 1 and 2, the present invention is applicable to routers of any suitable types and a fixed-based router is taken as an example herein for illustrating the present invention. The router to which the present invention is applied comprises a housing assembly 1 that is mounted on a base 2 and a control unit 4 that is supported on the base 2 and, preferably, mounted to the housing assembly 1. The router also comprises a wireless remote control device 3 that transmits signals to the control unit 4 and receives signals from the control unit 4 in a wireless manner. Thus, no wire is provided between the control unit 4 and the remote control device 3. An example of the wireless arrangement between the control unit 4 and the remote control device 3 is particularly shown in FIG. 5, which will be further described.

The wireless remote control device 3 comprises a first electrical circuit, which is preferably housed in an enclosure (not labeled) for dust and contamination protection and comprises a first input device 31 and a first display 32, both mounted on a surface of the enclosure for easy access by an operator of the router. The first input device 31 allows the operator to enter instruction and data, which are applied to a first processor (not shown), such as a microcontroller or microprocessor based device, built in the first circuit, and are converted into corresponding radio signals. The first electrical circuit comprises a first transmitter (not shown) that transmits the radio signals through an antenna 33. The first display 32 provides a visual display of the instruction or data entered by the operator.

Although not shown, a power supply, which can be a built-in device or an external device/source, supplies power to the remote control device 3.

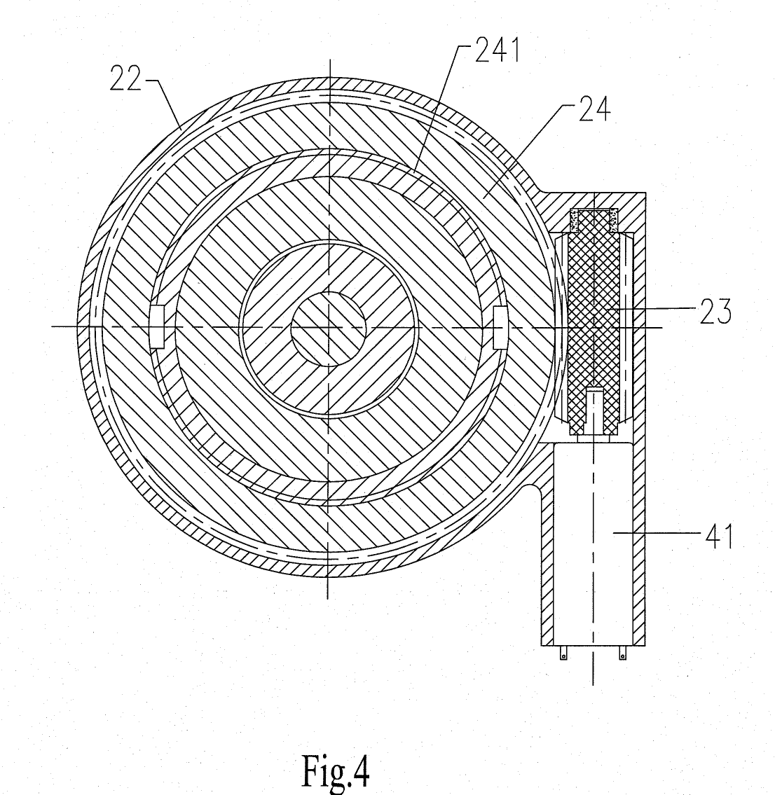

The control unit 4, which is mounted on the base 2, comprises a second electrical circuit consisted of a second receiver (not shown) that receives the radio signals from the remote control device 3 and a second processor (not shown) for processing the received radio signals and generating, in response thereto, a control signal for controlling a control motor 41 (shown in FIG. 4) and a second display 42, both constituting partly the second electrical circuit. The operation of the control motor 41 will be further described.

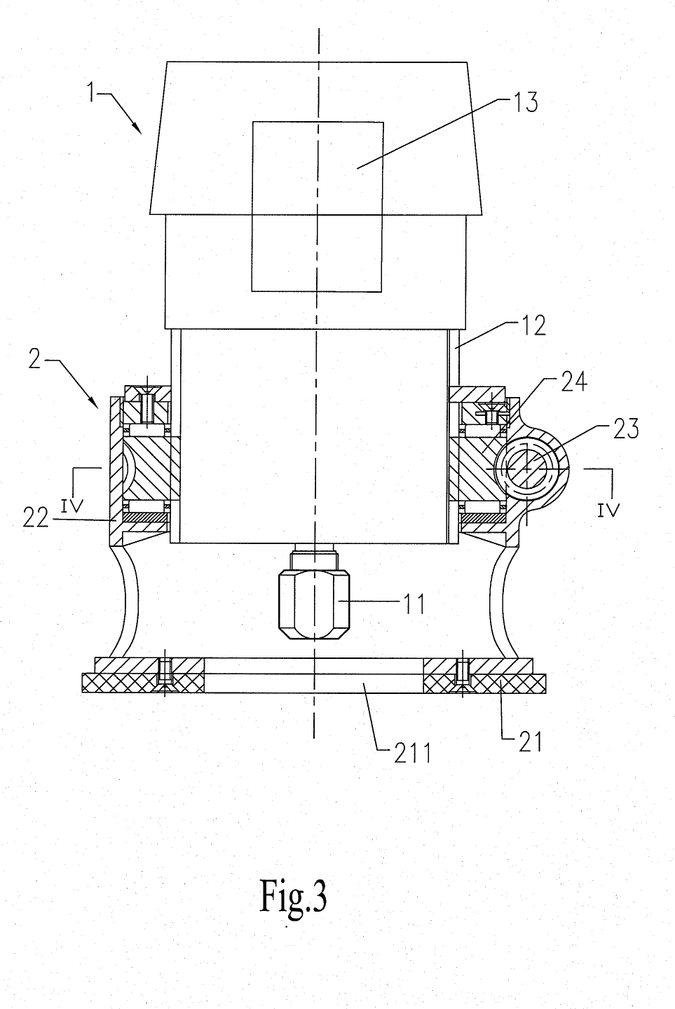

Also referring to FIGS. 3 and 4, the router comprises a drive motor 13 that is housed and retained in the housing assembly 1 and is coupled to tool bit 11, preferably through a shaft (not shown). Thus, the operation of the drive motor 13 selectively drives rotation of the tool bit 11 to work on a workpiece. An outer thread 12 is formed on an outer circumference of the housing assembly 1.

The base 2 comprises a generally planar surface 21 in which an opening or a hole 211 is defined for the selective extension of the tool bit 11 therethrough and a surrounding wall 22 mounted on and extending from the planar surface 21 in an axial direction. The wall 22 delimits a cylindrical internal space in which a worm gear 24 is concentrically and rotatably received. Preferably, the wall 22 is cylindrical and forms the cylindrical internal space. A worm 23 is rotatably mounted to the wall 22 and mates the worm gear 24 through an opening (not labeled) defined in the wall 22. The worm 23 is operatively coupled to the control motor 41 that is mounted to the base 2 (preferably the wall 22 of the base 2) so that operation of the motor 41 drives the rotation of the worm 23, which in turn rotates the worm gear 24.

The worm gear 24 forms a central bore 241 through which the housing assembly 1 extends. The central bore 241 has an inside surface in which an inner thread (not labeled) is formed form engaging the outer thread 12 of the housing assembly 1. Thus, a screw-based transmission is formed between the worm gear 24 and the housing assembly 1 to enable axial movement of the housing assembly 1 with respect to the base 2 by the rotation of the worm gear 24. The control motor 41, which is mounted to the base 2, has a spindle (not labeled) to which the worm 23 is mounted to be driven by the control motor 41. The spindle of the control motor 41 can assume any suitable orientation with respect to the axial direction of the housing assembly 1 or that of the cylindrical wall 22, provided proper mating and torque transmission between the worm 23 and the worm gear 24 are realized. Preferably, the spindle of the control motor 41 is normal to the axial direction of the housing assembly 1 and is thus perpendicular to the shaft that couples the tool bit 11 to the drive motor 13.

Thus, the torque or rotation of the motor 41 is transmitted through a gear train consisting of the worm 23 and the worm gear 24 to the housing assembly 1 for axially moving the housing assembly 1. Apparently, the gear train can be of different arrangement and configuration.

The operation of the control motor 31 drives the worm 23 to rotate the worm gear 24, which due to the screw-based transmission between the worm gear 24 and the housing assembly 1, moves the housing assembly 1 in the axial direction to selectively approach or space from the base 2. Consequently, the tool bit 11 that is carried by the housing assembly 1 is moved with respect to the base 2 on which a workpiece (not shown) is supported to change or adjust depth of cutting in the workpiece by the tool bit 11.

To carry out adjustment of cutting depth in a workpiece, an operator manipulate the first input device 31 of the wireless remote control device 3, which is separate from the housing assembly 1 and the base 2, to enter an instruction for setting for example a desired cutting depth, which instruction is applied by the first circuit to the first processor and is converted into a radio signal. The radio signal that represents the operator's instruction regarding cutting depth is transmitted by the first transmitter through the antenna 33. Further, the operator's instruction is displayed on the first display 32 for visual inspection and verification of the cutting depth set by the operator.

The radio signal is received by the second receiver of the second circuit of the control unit 4 mounted to the base 2. The radio signal is processed by the second processor to obtain a control signal that is applied to and controls the operation of the control motor 41 to drive the worm 23 and thus moving the housing assembly 1 for adjusting the depth of cutting performed by the tool bit 11 with respect to the workpiece retained on the base 2. At the same time, the second processor issues an information signal carrying information of the cutting depth of the tool bit 11 to the second display 42 for visibly displaying the cutting depth.

The radio signal that is transmitted between the remote control device 3 and the control unit 4 of the router can be of any suitable magnitude and frequency that are allowed by radio frequency regulations. For example, the radio signal can be transmitted with an ultrahigh frequency (UHF) within a range from 300 to 3,000 MHz, such as 433.92 MHz. The radio signal can be frequency modulated or amplitude modulated or the likes.

The foregoing description details only an embodiment of the present invention and it is apparent to those having ordinary skills that variations and modifications can be made on the embodiment given without departing from the spirit and scope of the present invention. For example, the control unit 4 that was just shown mounted to the base 2 in the previously preferred embodiment can be alternatively mounted to the housing assembly 1. Further, the control unit 4 can be further provided with a second input device 43 through which an operator of the router can directly enter instructions or carry out other manipulation, rather than entering the instruction through the remote control device 3.

If desired, the router may further comprises detection means for real-time position detection of for example the tool bit 11, and a position signal is applied to the second processor by which a radio signal corresponding to the position is obtained. The second electrical circuit of the control unit 4 comprises a second transmitter electrically connected to the second processor for transmitting the radio signal of the position. The first circuit of the remote control device 3 is correspondingly provided with a first receiver to receive the radio signal of position and applying the signal to the first processor. The radio signal of position can thus be processed by the first processor and a signal carrying the position information can be shown in the first display 32. The position of the tool bit 11 is associated with the cutting depth performed by the tool bit 11 and thus the position information provided by the position signal can be correlated to the cutting depth so that the first display 32 may show actual cutting depth of the tool bit 11 for visual inspection.

Apparently, both the remote control device 3 and the control unit 4 can be provided with a transceiver, rather than separate transmitter and receiver, for bi-directional signal transmission.

The present invention provides the router with a depth adjustment mechanism constituted with a wireless remote control device, which is convenient and straightforward for free hand use, especially for adjusting the depth of cutting in a fixed-base router that can be mounted in an inverted position beneath a router table 5 as shown in FIG. 5. The tool bit 11 of the fixed-base router extends through a hole 51 defined in the router table 5 for proceeding with cutting operation. Incorporating a wireless remote control device in the operation of adjusting the depth of cutting prevents the user from unnecessarily stooping down for observing and adjusting the depth of cutting, thereby enhancing the efficiency of operation.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A router comprising:
a base adapted to retain a workpiece thereon;
a housing assembly carrying a tool bit to work on the workpiece by a cutting depth on the workpiece, the housing assembly being movable with respect to the base to change position of the tool bit with respect to the workpiece and thus adjusting the cutting depth on the workpiece;
a driving device for driving the movement of the housing assembly with respect to the base through a transmission in response to a control signal applied thereto; and
depth adjustment means comprising a wireless remote control device and a control unit that are separate from each other and are communicateable with each other in a wireless manner, wherein:
the wireless remote control device is adapted to be operable by an operator to generate a radio signal, and
the control unit selectively receives the radio signal from the wireless remote control device in a wireless manner and converts the received radio signal into the control signal that is applied to the driving device.

2. The router as claimed in claim 1, wherein the transmission comprises a gear train arranged between the driving device and the housing assembly.

3. The router as claimed in claim 2, wherein the gear train comprises a first gearing member mounted to the housing assembly and a mated second gearing member that is operatively coupled to the driving device.

4. The router as claimed in claim 3, wherein the first gearing member comprises a worm gear that is concentrically mounted to the housing assembly and wherein the second gearing member comprises a worm mating the worm gear and driven by the driving device.

5. The router as claimed in claim 4, wherein the base comprises a cylindrical wall defining a cylindrical interior space in which the worm gear is rotatably and concentrically received and retained and wherein the worm is rotatably supported on the base and mates the worm gear through an opening defined in the wall.

6. The router as claimed in claim 5, wherein the driving device comprises a motor that is mounted to the base and is operatively coupled to the worm, and wherein the motor is electrically connected to the control unit to receive the control signal for driving rotation of the worm that is transmitted the worm gear to drive the movement of the housing assembly.

7. The router as claimed in claim 6, wherein the transmission further comprises means for converting the rotation of the worm gear into the movement of the housing assembly.

8. The router as claimed in claim 7, wherein the worm gear forms a central bore through which the housing assembly extends, and wherein the means for converting the rotation of the worm gear into the movement of the housing assembly comprises a first internal thread formed in an inside surface of the central bore of the worm gear and a second external thread formed in an outer circumference of the housing assembly, the first and second threads engaging each other to form a screw-based transmission that converts the rotation of the worm gear into linear movement of the housing assembly.

9. The router as claimed in claim 1, wherein the base comprises a generally planar surface on which the workpiece is retained and a cylindrical wall mounted on and extending from the planar surface in an axial direction, and wherein the transmission comprises a worm gear rotatably and concentrically received and retained inside the cylindrical wall and defining a central bore through which the housing assembly extends and a worm operatively coupled to the driving device and mating the worm gear to induce rotation of the worm gear inside the cylindrical wall, the transmission further comprising a first internal thread formed in an inside surface of the central bore of the worm gear and a second external thread formed in an outer circumference of the housing assembly, the first and second threads engaging each other to form a screw-based transmission that converts the rotation of the worm gear into a linear movement of the housing assembly in the axial direction.

10. The router as claimed in claim 9, wherein the driving device comprises a motor mounted to the base and having a spindle operatively coupled to and driving rotation of the worm is mounted, the worm being arranged in a direction substantially normal to the axial direction, the rotation of the worm being transmitted to the worm gear through the engagement therebetween so as to induce the linear movement of the housing assembly.

11. The router as claimed in claim 1, wherein the base comprises a generally planar surface on which the workpiece is retained, a hole being formed in the planar surface for selective extension of the tool bit for working on the workpiece.

12. The router as claimed in claim 1, wherein the wireless remote control device comprises a first input device operable by the operator to receive an instruction and generate a corresponding instruction signal that is converted by the wireless remote control device into the radio signal.

13. The router as claimed in claim 12, wherein the wireless remote control device comprises a first display that provides a visual display of the instruction set by the operator.

14. The router as claimed in claim 12, wherein wireless remote control device comprises a processor based circuit that receives and converts the instruction signal into the radio signal.

15. The router as claimed in claim 1, wherein the wireless remote control device comprises a transmitter that transmits the radio signal and wherein the control unit comprises a receiver that receives the radio signal from the transmitter in a wireless manner.

16. The router as claimed in claim 1, wherein the control unit comprises a second display for displaying a message carried by the radio signal transmitted from the remote control device.

17. The router as claimed in claim 16, wherein the message carried by the radio signal comprises setting of cutting depth.

18. The router as claimed in claim 16, wherein the second display is mounted to the housing assembly.

19. The router as claimed in claim 16, wherein the second display is mounted to the base.

20. The router as claimed in claim 1 further comprising position detection means to detect a position of the tool bit and wherein at least one of the control unit and the remote control device comprises a display for providing visual display of the detected position of the tool bit.
